(19) United States
(12) Patent Application Publication
(10) Pub. No.: US 2019/0090321 A1
(43) Pub. Date: Mar. 21, 2019

(54) BACKLIGHT UNIT CAPABLE OF CONTROLLING BRIGHTNESS AND DISPLAY APPARATUS HAVING THE SAME

(71) Applicant: Samsung Display Co., Ltd., Yongin-Si (KR)

(72) Inventors: Dae-sik LEE, Hwaseong-si (KR); Yanguk NAM, Hwaseong-si (KR); Songyi HAN, Asan-si (KR)

(21) Appl. No.: 16/130,186

(22) Filed: Sep. 13, 2018

(30) Foreign Application Priority Data
Sep. 18, 2017 (KR) 10-2017-0119771

(51) Int. Cl. H05B 33/08; G09G 3/34; G09G 3/36

(52) U.S. Cl. CPC H05B 33/0818; G09G 3/3426; G09G 2320/0626; H05B 33/083; H05B 33/0845; G09G 3/3611

(57) ABSTRACT

A backlight unit includes a power converter which generates a light source power voltage to a power node, a first light emitting diode string connected between the power node and a first node to receive the light source power voltage through the power node, a second light emitting diode string connected between the power node and a second node to receive the light source power voltage through the power node, and a current controller which controls a current flowing through the first node of the first light emitting diode string and a current flowing through the second node of the second light emitting diode string in response to a dimming voltage signal. The current controller includes a switching unit which electrically connects the first node of the first light emitting diode string to the second node of the second light emitting diode string in response to a mode enable signal.

This patent application claims priority to Korean Patent Application No. 10-2017-0119771, filed on Sep. 18, 2017, and all the benefits accruing therefrom under 35 U.S.C. § 119, the content of which in its entirety is herein incorporated by reference.

### BACKGROUND

### 1. Field

Exemplary embodiments of the invention relate to a backlight unit capable of controlling a brightness and a display apparatus including the backlight unit.

### 2. Description of the Related Art

Installation of a display apparatus in electronic devices as a user interface has become essential, and a flat panel display apparatus is widely used as the display apparatus to achieve reduction in size and power consumption of the electronic devices.

A liquid crystal display apparatus, which is one of the most widely used types of flat panel display apparatus, is a light receiving display apparatus that controls an amount of light to display an image, and thus the liquid crystal display apparatus uses a separate light source, e.g., a backlight unit including a backlight lamp, to provide the light to a liquid crystal display panel.

### SUMMARY

In recent years, a light emitting diode (“LED”) having desired characteristics of low voltage, environmental-friendly, and thin thickness is widely used. However, maintaining uniformity of brightness and color over an entire surface of the display apparatus may be difficult in terms of optical design of the LED, such that new technology may be desired for instantaneous LED current control.

The backlight unit may include a plurality of LED strings to realize desired brightness for the display apparatus. The brightness of the light emitting diode strings may be achieved by controlling an amount of current flowing through each light emitting diode string.

The disclosure provides a backlight unit capable of increasing a brightness dynamic range and providing lower brightness.

The disclosure provides a display apparatus including the backlight unit.

According to an embodiment of the invention, a backlight unit includes a power converter which generates a light source power voltage to a power node, a first light emitting diode string connected between the power node and a first node to receive the light source power voltage through the power node, a second light emitting diode string connected between the power node and a second node to receive the light source power voltage through the power node, and a current controller that controls a current flowing through the first node of the first light emitting diode string and a current flowing through the second node of the second light emitting diode string in response to a dimming voltage signal. In such an embodiment, the current controller includes a switching unit which electrically connects the first node of the first light emitting diode string to the second node of the second light emitting diode string in response to a mode enable signal.

In an embodiment, the current controller may substantially simultaneously control the current flowing through the first node of the first light emitting diode string and the current flowing through the second node of the second light emitting diode string in response to the dimming voltage signal when the mode enable signal is at a first level.

In an embodiment, the current controller may further include a feedback control circuit which generates a first feedback voltage corresponding to the current flowing through the first node and a second feedback voltage corresponding to the current flowing through the second node, and a dimming control circuit which outputs a first current control signal based on the dimming voltage signal and the first feedback voltage and outputs a second current control signal based on the dimming voltage signal and the second feedback voltage. In such an embodiment, the feedback control circuit may control the current flowing through the first node in response to the first current control signal, and control the current flowing through the second node in response to the second current control signal.

In an embodiment, the feedback control circuit may control the current flowing through the second node in response to the second current control signal when the mode enable signal is at a second level.

In an embodiment, the feedback control circuit may include a first current control transistor connected between the first node and a third node and including a control electrode which receives the first current control signal, a first resistor connected between the third node and a ground terminal, a control switching unit which selectively outputs the second current control signal as a third current control signal in response to the mode enable signal, a second current control transistor connected between the second node and a fourth node and including a control electrode which receives the third current control signal, and a second resistor connected between the fourth node and the ground terminal.

In an embodiment, the dimming control circuit may include a level shifter which converts the dimming voltage signal to a first reference voltage and a second reference voltage, a first comparator which compares the first reference voltage with the first feedback voltage to output the first current control signal, and a second comparator which compares the second reference voltage with the second feedback voltage to output the second current control signal.

In an embodiment, the level shifter may convert the dimming voltage signal to the first reference voltage and the second reference voltage, where each of the first reference voltage and the second reference voltage may be in a range between an upper limit voltage level and a lower limit voltage level.

In an embodiment, the current controller may control the current flowing through the first node such that the current flowing through the first node becomes lower than a current corresponding to the lower limit voltage level of the first reference voltage when the mode enable signal is at a first level and the first reference voltage is at the lower limit voltage level.

In an embodiment, the current controller may control the current flowing through the first node such that the current flowing through the first node varies to a current corresponding to the lower limit voltage level of the first reference voltage when the mode enable signal is at a second level and the first reference voltage is at the lower limit voltage level.

In an embodiment, the level shifter may further receive the mode enable signal and generate the first reference voltage corresponding to a variation in voltage level of the dimming voltage signal and the mode enable signal.

According to another embodiment of the invention, a display apparatus includes a display panel including a plurality of pixels, a driving circuit controlling the display panel to display an image, and a backlight unit providing a light to the display panel. In such an embodiment, the backlight unit includes a power converter which generates a light source power voltage to a power node, a first light emitting diode string connected between the power node and a first node to receive the light source power voltage through the power node, a second light emitting diode string connected between the power node and a second node to receive the light source power voltage through the power node, and a current controller which controls a current flowing through the first node of the first light emitting diode string and a current flowing through the second node of the second light emitting diode string in response to a dimming voltage signal. In such an embodiment, the current controller includes a switching unit which electrically connects the first node of the first light emitting diode string to the second node of the second light emitting diode string in response to a mode enable signal.

In an embodiment, the driving circuit may provide the dimming voltage signal and the mode enable signal to the backlight unit.

In an embodiment, the current controller may substantially simultaneously control the current flowing through the first node of the first light emitting diode string and the current flowing through the second node of the second light emitting diode string in response to the dimming voltage signal when the mode enable signal is at a first level.

In an embodiment, the current controller may further include a feedback control circuit which generates a first feedback voltage corresponding to the current flowing through the first node and a second feedback voltage corresponding to the current flowing through the second node, and a dimming control circuit which outputs a first current control signal based on the dimming voltage signal and the first feedback voltage and outputs a second current control signal based on the dimming voltage signal and the second feedback voltage. In such an embodiment, the feedback control circuit may control the current flowing through the first node in response to the first current control signal and control the current flowing through the second node in response to the second current control signal.

In an embodiment, the feedback control circuit may control the current flowing through the second node in response to the second current control signal when the mode enable signal is at a second level.

In an embodiment, the feedback control circuit may include a first current control transistor connected between the first node and a third node and including a control electrode which receives the first current control signal, a first resistor connected between the third node and a ground terminal, a control switching unit which selectively outputs the second current control signal as a third current control signal in response to the mode enable signal, a second current control transistor connected between the second node and a fourth node and including a control electrode which receives the third current control signal, and a second resistor connected between the fourth node and the ground terminal.

In an embodiment, the dimming control circuit may include a level shifter which converts the dimming voltage signal to a first reference voltage and a second reference voltage, a first comparator which compares the first reference voltage with the first feedback voltage to output the first current control signal, and a second comparator which compares the second reference voltage with the second feedback voltage to output the second current control signal.

In an embodiment, the level shifter may convert the dimming voltage signal to the first reference voltage and the second reference voltage, where each of the first reference voltage and the second reference voltage may be in a range between an upper limit voltage level and a lower limit voltage level.

In an embodiment, the current controller may control the current flowing through the first node such that the current flowing through the first node becomes lower than a current corresponding to the lower limit voltage level of the first reference voltage when the mode enable signal is at a first level and the first reference voltage is at the lower limit voltage level.

In an embodiment, the driving circuit may include a data driver which drives a plurality of data lines, a gate driver which drives a plurality of gate lines, and a timing controller which controls the data driver and the gate driver in response to an image signal and a control signal, which are provided from an external source. In such an embodiment, the timing controller provides the dimming voltage signal and the mode enable signal to the backlight unit.

According to embodiments described herein, the light emitting diode strings are connected to each other in parallel, and thus the brightness of the backlight unit may be more lowered. Therefore, the brightness dynamic range of the display apparatus may increase.

### BRIEF DESCRIPTION OF THE DRAWINGS

The above and other features of the invention will become readily apparent by reference to the following detailed description when considered in conjunction with the accompanying drawings, in which:

FIG. 1 is a block diagram showing a display apparatus according to an exemplary embodiment of the disclosure;

FIG. 2 is a circuit diagram showing a configuration of a backlight unit according to an exemplary embodiment of the disclosure;

FIG. 3 is a circuit diagram showing a configuration of a voltage controller according to an exemplary embodiment of the disclosure;

FIG. 4 is a timing diagram showing signals for an operation of a voltage controller according to an exemplary embodiment of the disclosure;

FIG. 5 is a circuit diagram showing a configuration of a current controller according to an exemplary embodiment of the disclosure;

FIG. 6 is a timing diagram showing signals for an operation of a backlight unit according to an exemplary embodiment of the disclosure;

FIG. 7 is a circuit diagram showing a configuration of a backlight unit according to an alternative exemplary embodiment of the disclosure;

FIG. 8 is a circuit diagram showing a configuration of a backlight unit according to another alternative exemplary embodiment of the disclosure; and

FIG. 9 is a timing diagram showing signals for an operation of a backlight unit according to an alternative exemplary embodiment of the disclosure.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein. The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the disclosure, and will not be interpreted in an idealized or overly formal sense unless expressly so defined herein.

Hereinafter, exemplary embodiments of the invention will be described in detail with reference to the accompanying drawings.

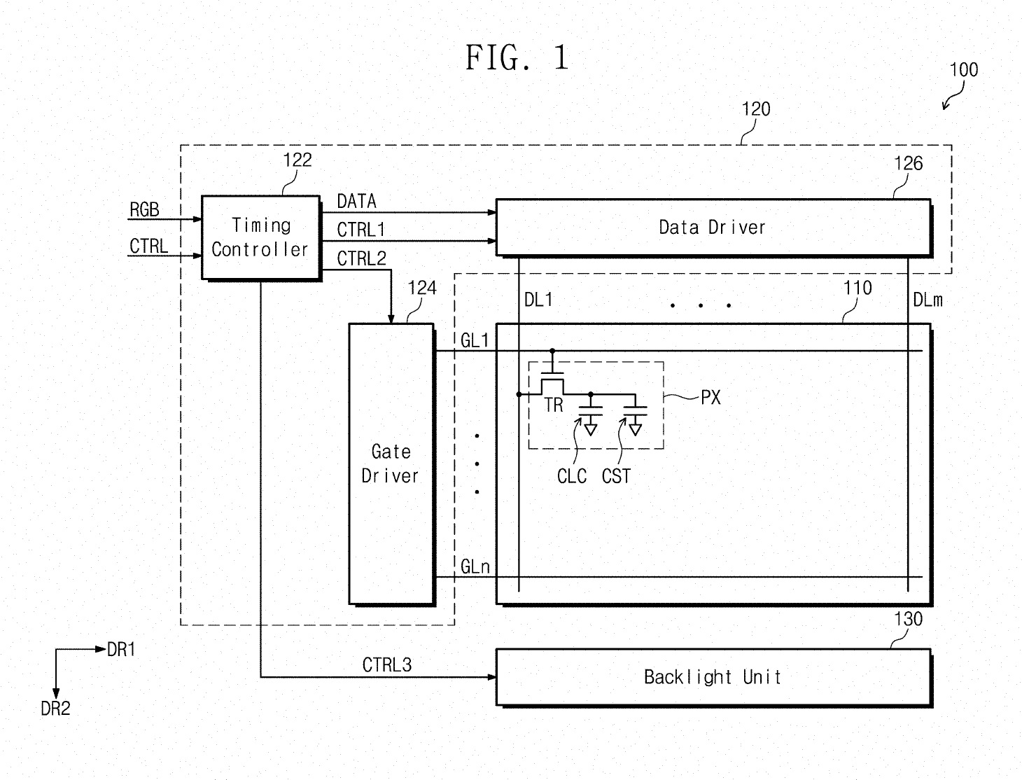

FIG. 1 is a block diagram showing a display apparatus 100 according to an exemplary embodiment of the disclosure.

Referring to FIG. 1, an exemplary embodiment of the display apparatus 100 includes a display panel 110, a driving circuit 120, and a backlight unit 130.

The display panel 110 displays an image. In an exemplary embodiment, the display panel 110 may be a liquid crystal display panel, but the invention is not limited thereto. Alternatively, the display panel 110 may be other types of display panels that use the backlight unit 130.

In an exemplary embodiment, the display panel 110 includes a plurality of gate lines GL1 to GLn extending in a first direction DR1, a plurality of data lines DL1 to DLm extending in a second direction DR2, and a plurality of pixels PX connected to the gate lines GL1 to GLn and the data lines DL1 to DLm. In one exemplary embodiment, for example, the pixels PX may be arranged in areas defined by the gate lines GL1 to GLn and the data lines DL1 to DLm crossing the gate lines GL1 to GLn. The data lines DL1 to DLm are insulated from the gate lines GL1 to GLn. Each of the pixels PX includes a thin film transistor TR, a liquid crystal capacitor CLC, and a storage capacitor CST.

The pixels PX have a same structure as each other. Accordingly, the structure of one pixel will be described in detail, and any repetitive detailed description of other pixels will be omitted for convenience of description. In an exemplary embodiment, as shown in FIG. 1, the thin film transistor TR of a pixel PX includes a gate electrode connected to a first gate line GL1 among the gate lines GL1 to GLn, a source electrode connected to a first data line DL1 to DLm among the data lines DL1 to DLm, and a drain electrode commonly connected to the liquid crystal capacitor CLC and the storage capacitor CST. One end of each of the liquid crystal capacitor CLC and the storage capacitor CST is connected to the drain electrode of the thin film transistor TR in parallel, and the other end of each of the liquid crystal capacitor CLC and the storage capacitor CST is connected to a common voltage.

In an exemplary embodiment, the driving circuit 120 includes a timing controller 122, a gate driver 124, and a data driver 126. The timing controller 122 receives image signals RGB and control signals CTRL from an external source (not shown). The control signals CTRL includes, for example, a vertical synchronization signal, a horizontal synchronization signal, a main clock signal, and a data enable signal. The timing controller 122 provides an image data signal DATA, which is obtained by processing the image signals RGB to correspond to an operation condition of the display panel 110 based on the control signals CTRL, and a first control signal CTRL1 to the data driver 126, and the timing controller 122 provides a second control signal CTRL2 to the gate driver 124. The first control signal CTRL1 includes a horizontal synchronization start signal, a clock signal and a line latch signal, and the second control signal CTRL2 includes a vertical synchronization start signal, an output enable signal and a gate pulse signal. The timing controller 122 may change the image data signal DATA in various ways depending on an arrangement of the pixels PX of the display panel 110 and a display frequency of the display panel 110, and output the changed image data signal DATA. The timing controller 122 provides a third control signal CTRL3 to the backlight unit 130 to control the backlight unit 130.

The gate driver 124 drives the gate lines GL1 to GLn in response to the second control signal CTRL2 from the timing controller 122. In an exemplary embodiment, the gate driver 124 may include a gate driving integrated circuit. According to an alternative exemplary embodiment, the gate driver 124 may be implemented by a circuit with oxide semiconductor, amorphous semiconductor, crystalline semiconductor, polycrystalline semiconductor, or the like, and formed in a predetermined area of the display panel 110. In such an embodiment, the gate driver 124 may be substantially formed with the pixels PX through a same thin film process.

The data driver 126 drives the data lines DL1 to DLm in response to the image data signal DATA and the first control signal CTRL1 from the timing controller 122.

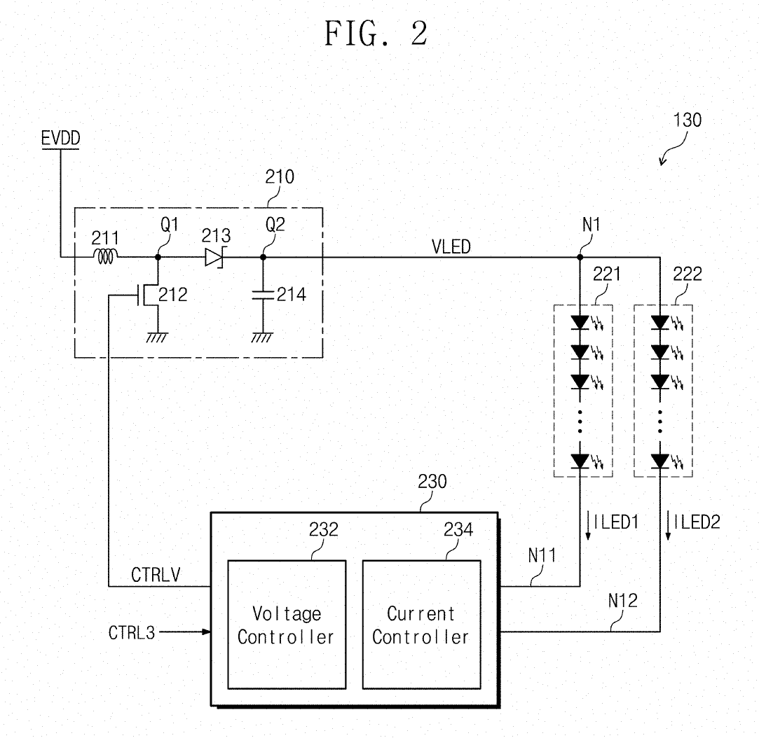

The backlight unit 130 may be disposed under the display panel 110 to face the pixels PX. The backlight unit 130 operates in response to the third control signal CTRL3 from the timing controller 122. The configuration and operation of the backlight unit 130 will hereinafter be described in detail with reference to FIG. 2.

FIG. 2 is a circuit diagram showing a configuration of the backlight unit 130 shown in FIG. 1 according to an exemplary embodiment of the disclosure.

Referring to FIG. 2, an exemplary embodiment of the backlight unit 130 includes a power converter 210, a first light emitting diode string 221, a second light emitting diode string 222 and a light source controller 230. In an exemplary embodiment, the backlight unit 130 is used as the light source of the display panel 110 shown in FIG. 1, but the invention is not limited thereto. Alternatively, the backlight unit 130 may be applied to various fields, such as lighting, advertisement panels, etc.

In an exemplary embodiment, the power converter 210 converts a power voltage EVDD from an external source to a light source power voltage VLED. The light source power voltage VLED is controlled to have a voltage level enough to drive the first and second light emitting diode strings 221 and 222.

The power converter 210 includes an inductor 211, a transistor 212, a diode 213 and a capacitor 214. The inductor 211 is connected between the power voltage EVDD and a first inner node Q1. The transistor 212 is connected to the first inner node Q1 and a ground terminal applied with a ground voltage. The transistor 212 includes a first electrode connected to the first inner node Q1, a second electrode connected to the light source controller 230, and a control electrode connected to the light source controller 230 to receive a voltage control signal CTRLV. In an exemplary embodiment shown in FIG. 2, the transistor 212 may be a field effect transistor (“FET”) or a bipolar junction transistor (“BJT”). In an alternative exemplary embodiment, the transistor 212 is a metal-oxide-semiconductor FET (“MOSFET”) having an n-type channel.

The diode 213 is connected between the first inner node Q1 and a second inner node Q2. In an exemplary embodiment, the diode 213 may be, but not limited to, a schottky diode. The capacitor 214 is connected between the second inner node Q2 and the ground terminal applied with the ground voltage. The light source power voltage VLED of the second inner node Q2 is provided to the first and second light emitting diode strings 221 and 222.

The power converter 210 converts the power voltage EVDD from the external source to the light source power voltage VLED, and outputs the light source power voltage VLED. In such an embodiment, the transistor 212 is turned on or off in response to the voltage control signal CTRLV applied to the control electrode of the transistor 212, and thus the voltage level of the light source power voltage VLED is controlled.

In an exemplary embodiment, the backlight unit 130 includes two LED strings, i.e., the first light emitting diode string 221 and the second light emitting diode string 222, but the number of the LED strings is not limited to two.

Each of the first light emitting diode string 221 and the second light emitting diode string 222 includes a plurality of light emitting diodes (“LED”s) connected to each other in series. Each of the LEDs includes a white LED that emits a white color, a red LED that emits a red color, a blue LED that emits a blue color, and a green LED that emits a green color. The white LED, the red LED, the blue LED and the green LED have different emitting characteristics from each other, and have different forward driving voltages to emit the light, from each other. In an exemplary embodiment, the LEDs are implemented by LEDs driven by a relatively low forward driving voltage to reduce power consumption. In an exemplary embodiment, a difference in forward driving voltage between the LEDs may be small to secure a uniformity of brightness. In an exemplary embodiment, each of the first light emitting diode string 221 and the second light emitting diode string 222 includes a plurality of LEDs, and the LEDs may include a laser diode and a carbon nano tube.

One end of each of the first light emitting diode string 221 and the second light emitting diode string 222 is connected to a power node N1 that receives the light source power voltage VLED from the power converter 210. The other ends of the first light emitting diode string 221 and the second light emitting diode string 222, i.e., a first node N11 and a second node N12, are connected to the light source controller 230.

In an exemplary embodiment, as shown in FIG. 2, the light source controller 230 outputs the voltage control signal CTRLV corresponding to voltage levels feedback from the first light emitting diode string 221 and the second light emitting diode string 222 in response to the third control signal CTRL3 from the timing controller 122 shown in FIG. 1. In such an embodiment, the light source controller 230 controls currents respectively flowing through the first light emitting diode string 221 and the second light emitting diode string 222 in response to the third control signal CTRL3 and the voltage levels feedback from the first light emitting diode string 221 and the second light emitting diode string 222.

The light source controller 230 includes a voltage controller 232 and a current controller 234. The voltage controller 232 outputs the voltage control signal CTRLV having a pulse width corresponding to a voltage variation of the other ends of the first light emitting diode string 221 and the second light emitting diode string 222, i.e., the first and second nodes N11 and N12.

In one exemplary embodiment, for example, when the pulse width of the voltage control signal CTRLV increases, a turned-on time of the transistor 212 increases. In such an embodiment, as the turned-on time of the transistor 212 increases, the voltage level of the light source power voltage VLED increases. In such an embodiment, when the pulse width of the voltage control signal CTRLV decreases, the turned-on time of the transistor 212 decreases. In such an embodiment, as the turned-on time of the transistor 212 decreases, the voltage level of the light source power voltage VLED decreases.

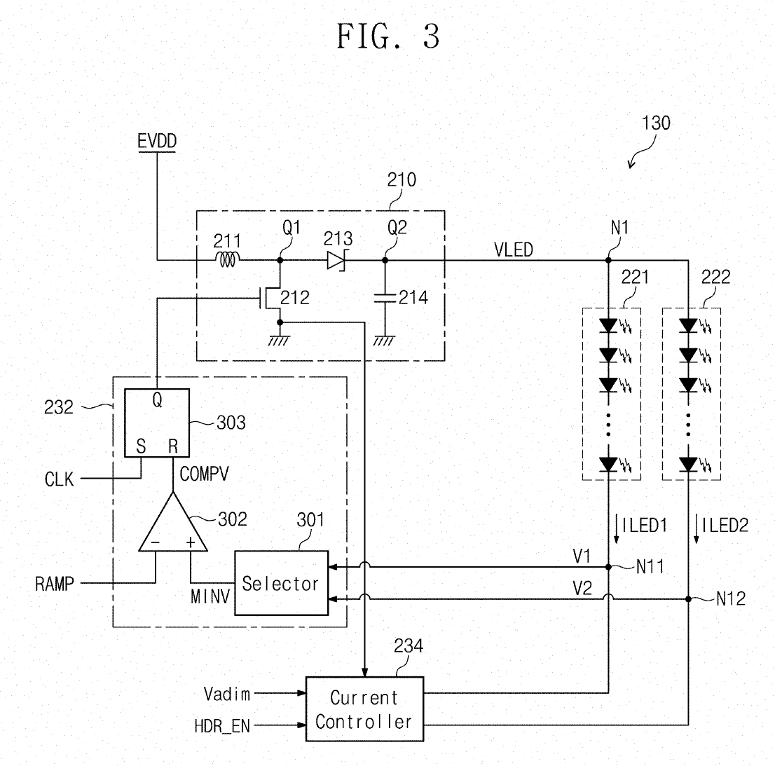

FIG. 3 is a circuit diagram showing a configuration of the voltage controller 232 shown in FIG. 2 according to an exemplary embodiment of the disclosure.

Referring to FIG. 3, an exemplary embodiment of the voltage controller 232 includes a selector 301, a comparator 302 and a latch circuit 303. The selector 301 is electrically connected to the other ends of the first and second light emitting diode strings 221 and 222, i.e., the first and second nodes N11 and N12. The selector 301 selects the lowest voltage of voltages V1 and V2 of the first and second nodes N11 and N12, and outputs the selected voltage as a minimum voltage MINV. The selector 301 may select the LED string having the greatest voltage drop between the first and second light emitting strings 221 and 222 by selecting the lowest voltage of the voltages V1 and V2 of the first and second nodes N11 and N12. In such an embodiment, the voltage controller 232 may output the voltage control signal CTRLV with respect to a voltage of the LED string having the greatest voltage drop.

The comparator 302 includes a non-inverting input terminal (+) that receives the minimum voltage MINV, an inverting input terminal (−) that receives a ramp signal RAMP, and an output terminal that outputs a voltage comparing signal COMPV. The comparator 302 compares the minimum voltage MINV and the ramp signal RAMP to output the voltage comparing signal COMPV based on a result of the comparison. The ramp signal RAMP is a periodic signal with a triangular pulse shape.

The latch circuit 303 outputs the voltage control signal CTRLV in synchronization with the voltage comparing signal COMPV and the clock signal CLK. The third control signal CTRL3 provided from the timing controller 122 shown in FIG. 1 includes the ramp signal RAMP and a clock signal CLK.

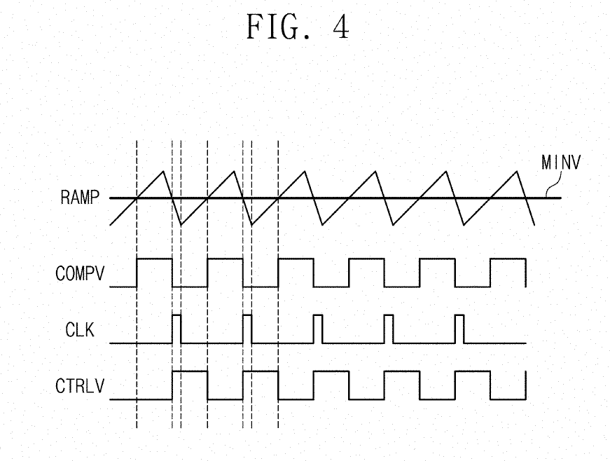

FIG. 4 is a timing diagram showing signals for an operation of the voltage controller shown in FIG. 3 according to an exemplary embodiment of the disclosure.

Referring to FIGS. 3 and 4, in an exemplary embodiment, the comparator 302 compares the minimum voltage MINV from the selector 301 with the ramp signal RAMP to output the voltage comparing signal COMPV based on a result of the comparison. As the voltage level of the minimum voltage MINV decreases, the pulse width of the voltage comparing signal COMPV increases, and as the voltage level of the minimum voltage MINV increases, the pulse width of the voltage comparing signal COMPV decreases.

The latch circuit 303 outputs the voltage control signal CTRLV in synchronization with the voltage comparing signal COMPV and the clock signal CLK. Since the pulse width of the clock signal CLK is constant, the pulse width of the voltage control signal CTRLV is determined depending on the pulse width of the voltage comparing signal COMPV. In such an embodiment, as the pulse width of the voltage control signal CTRLV increases, the turned-on time of the transistor 212 increases, and thus the voltage level of the light source power voltage VLED increases. In such an embodiment, as the pulse width of the voltage control signal CTRLV decreases, the turned-on time of the transistor 212 decreases, and thus the voltage level of the light source power voltage VLED decreases. In such an embodiment, since the pulse width of the voltage control signal CTRLV is determined depending on the voltage level of the minimum voltage MINV, the light source power voltage VLED may be controlled based on the voltage level of the minimum voltage MINV.

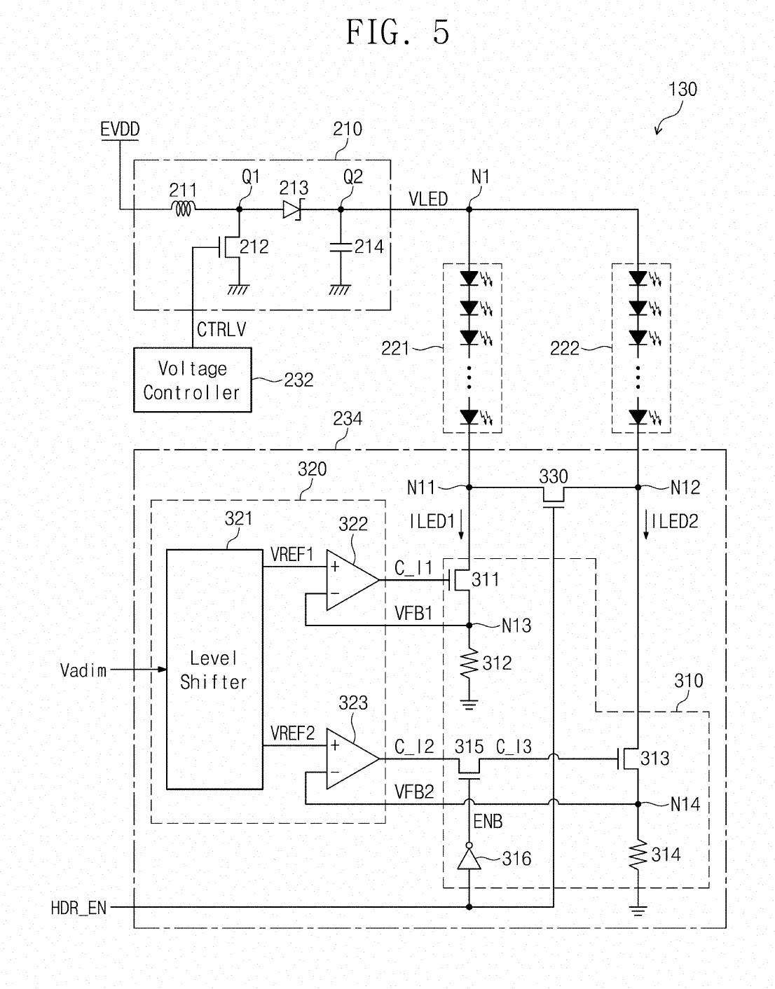

FIG. 5 is a circuit diagram showing a configuration of a current controller of a backlight unit according to an exemplary embodiment of the disclosure.

Referring to FIG. 5, an exemplary embodiment of the current controller 234 includes a feedback control circuit 310, a dimming control circuit 320 and a switching unit 330. The third control signal CTRL3 provided from the timing controller 122 shown in FIG. 1 includes a dimming voltage signal Vadim and a mode enable signal HDR_EN.

The feedback control circuit 310 generates a first feedback voltage VFB1 corresponding to a current of the first node N11, and generates a second feedback voltage VFB2 corresponding to a current of the second node N12.

The dimming control circuit 320 outputs a first current control signal C_I1 based on the dimming voltage signal Vadim and the first feedback voltage VFB1, and outputs a second current control signal C_I2 based on the dimming voltage signal Vadim and the second feedback voltage VFB2.

The feedback control circuit 310 controls the current of the first node N11 in response to the first current control signal C_I1 from the dimming control circuit 320. The feedback control circuit 310 selectively outputs the second current control signal C_I2 as a third current control signal C_I3 in response to the mode enable signal HDR_EN. In one exemplary embodiment, for example, when the mode enable signal HDR_EN is at a second level (e.g., a low level), the feedback control circuit 310 outputs the second current control signal C_I2 as the third current control signal C_I3. The feedback control circuit 310 controls the current of the second node N12 in response to the third current control signal C_I3. In one exemplary embodiment, for example, when the mode enable signal HDR_EN is at a first level (e.g., a high level), the feedback control circuit 310 does not output the second current control signal C_I2 as the third current control signal C_I3.

In an exemplary embodiment, as shown in FIG. 5, the feedback control circuit 310 includes a first transistor 311, a first resistor 312, a second transistor 313, a second resistor 314, a third transistor 315 and an inverter 316. The first transistor 311 includes one end connected to the first node N11, the other end connected to a third node N13, and a control electrode that receives the first current control signal C_I1. The first resistor 312 is connected between the third node N13 and the ground terminal that receives the ground voltage. The voltage of the third node N13 may be output as the first feedback voltage VFB1. The second transistor 313 includes one end connected to the second node N12, the other end connected to a fourth node N14, and a control electrode that receives the third current control signal C_I3. The second resistor 314 is connected between the fourth node N14 and the ground terminal that receives the ground voltage. The voltage of the fourth node N14 may be output as the second feedback voltage VFB2.

Each of the first and second transistors 311 and 313 may be, but not limited to, a current control transistor in which a current flowing through between the one end and the other end is controlled depending on a voltage applied to the control electrode thereof. Each of the first and second transistors 311 and 313 may be a FET or a BJT.

The inverter 316 receives the mode enable signal HDR_EN, and outputs an inverted enable signal ENB. The third transistor 315 is connected between an output terminal of a second comparator 323 of the dimming control circuit 320 and the control electrode of the second transistor 313, and includes a control electrode connected to an output terminal of the inverter 316.

In an exemplary embodiment, as shown in FIG. 5, the dimming control circuit 320 includes a level shifter 321, a first comparator 322 and the second comparator 323.

The level shifter 321 converts the dimming voltage signal Vadim to a first reference voltage VREF1 and a second reference voltage VREF2. The first comparator 322 compares the first reference voltage VREF1 with the first feedback voltage VFB1 to output the first current control signal C_I1 based on a result of the comparison. The second comparator 323 compares the second reference voltage VREF2 with the second feedback voltage VFB2 to output the second current control signal C_I2 based on a result of the comparison.

The switching unit 330 electrically connects the first node N11 of the first light emitting diode string 221 to the second node N12 of the second light emitting diode string 222 in response to the mode enable signal HDR_EN. The switching unit 330 may be, but not limited to, a transistor including one end connected to the first node N11, the other end connected to the second node N12, and a control electrode that receives the mode enable signal HDR_EN.

In an exemplary embodiment, the mode enable signal HDR_EN may have a first level, e.g., a high level of about 3.3 volts (V), when the display apparatus 100 shown in FIG. 1 operates in a high dynamic range (“HDR”) mode, and the dimming voltage signal Vadim is the lowest level. In such an embodiment, the mode enable signal HDR_EN may have a second level (e.g., a low level) when the display apparatus 100 shown in FIG. 1 operates in a normal mode or when the dimming voltage signal Vadim is not at the lowest level even though the display apparatus 100 shown in FIG. 1 operates in the HDR mode. According to an alternative exemplary embodiment, the mode enable signal HDR_EN may have the first level (e.g., the high level) during a low brightness mode in which the lowest brightness of the backlight is changed to be lower than the lowest brightness, and the mode enable signal HDR_EN may have the second level (e.g., the low level) during the normal mode.

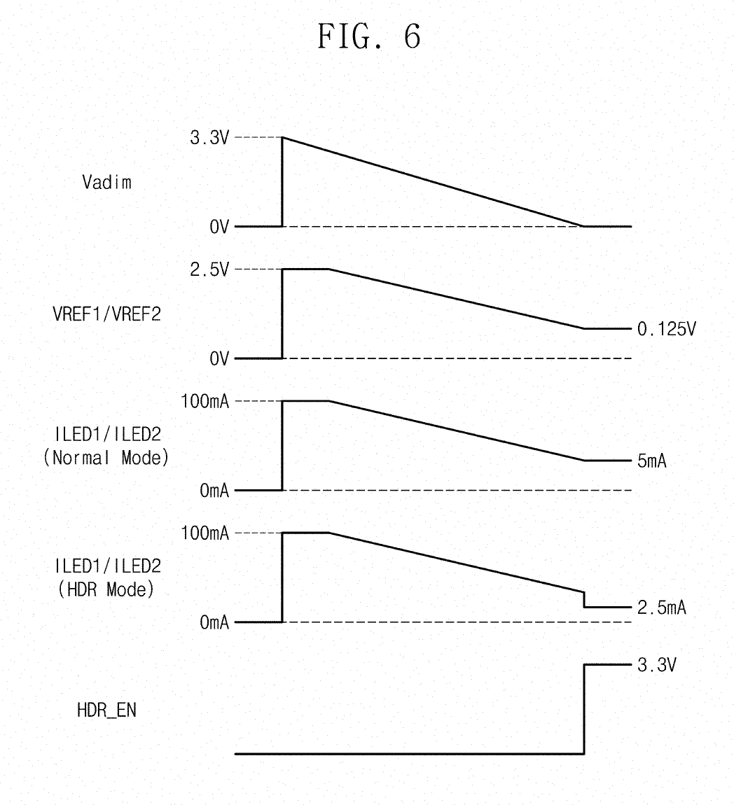

FIG. 6 is a timing diagram showing signals for an operation of a backlight unit according to an exemplary embodiment of the disclosure.

Referring to FIGS. 5 and 6, when the mode enable signal HDR_EN is at the second level (e.g., low level), the third transistor 315 is turned on, and the switching unit 330 is turned off.

The level shifter 321 converts the dimming voltage signal Vadim to the first reference voltage VREF1 and the second reference voltage VREF2. In one exemplary embodiment, for example, the dimming voltage signal Vadim has vale in a range from about 3.3 V to about zero (0) V, and each of the first reference voltage VREF1 and the second reference voltage VREF2 may be in a range from about 2.5 V to about 0.125 V. In such an embodiment, an upper limit voltage level of each of the first reference voltage VREF1 and the second reference voltage VREF2 is about 2.5 V and a lower limit voltage level of each of the first reference voltage VREF1 and the second reference voltage VREF2 is about 0.125 V. The lower limit voltage level of each of the first reference voltage VREF1 and the second reference voltage VREF2 may be determined in consideration of lower limit levels of the first and second feedback voltages VFB1 and VFB2, which are limited by the first and second resistors 312 and 314.

When each of the first reference voltage VREF1 and the second reference voltage VREF2 is output depending on the voltage level of the dimming voltage signal Vadim, the first and second comparators 322 and 323 compare the first and second reference voltages VREF1 and VREF2 with the first and second feedback voltages VFB1 and VFB2, respectively, to output the first current control signal C_I1 and the second current control signal C_I2. The second current control signal C_I2 may be output as the third current control signal C_I3 through the third transistor 315. A first current ILED1 flowing through the first transistor 311 and a second current ILED2 flowing through the second transistor 313 may be controlled depending on the voltage level of the first current control signal C_I1 and the third current control signal C_I3, respectively.

In one exemplary embodiment, for example, where the first reference voltage VREF1 and the second reference voltage VREF2 is in the range from about 2.5 V to about 0.125 V, the first current ILED1 and the second current ILED2 may have a current in a range from about 100 milliamperes (mA) to about 5 mA.

The light emitting brightness of the first light emitting diode string 221 and the light emitting brightness of the second light emitting diode string 222 are determined depending on the first current ILED1 and the second current ILED2, respectively. an exemplary embodiment, where the lower limit voltage level of the first reference voltage VREF1 and the second reference voltage VREF2 is about 0.125 V, the first current ILED1 and the second current ILED2 are at least about 5 mA, and thus there is a limitation to display low brightness.

When the mode enable signal HDR_EN is at the first level (e.g., the high level), the third transistor 315 is turned off, and the switching unit 330 is turned on. The turned-off third transistor 315 does not transmit the second current control signal C_I2 to the control electrode of the second transistor 313. When the mode enable signal HDR_EN is at the first level, the switching unit 330 is turned on, and thus the first node N11 of the first light emitting diode string 221 is electrically connected to the second node N12 of the second light emitting diode string 222. When the first node N11 and the second node N12 are electrically connected to each other, the current flowing through the first node N11 and the second node N12 may be controlled by the first transistor 311.

When the dimming voltage signal Vadim is maintained in the lowest level during the first level of the mode enable signal HDR_EN, the first reference voltage VREF1 is maintained in the lower limit voltage level (e.g., about 0.125 V). Accordingly, a sum of the current flowing through the first node N11 and the current flowing through the second node N12 may be controlled to be in a level corresponding to the lower limit voltage level of the first reference voltage VREF1.

As described above, in an exemplary embodiment where the first reference voltage VREF1 is at the lower limit voltage level (e.g., about 0.125 V) when the switching unit 330 is not turned on, the first current ILED1 is about 5 mA. Accordingly, since the sum of the current flowing through the first node N11 and the current flowing through the second node N12 when the switching unit 330 is turned on is about 5 mA corresponding to the lower limit voltage level (e.g., about 0.125 V) of the first reference voltage VREF1, the current flowing through each of the first light emitting diode string 221 and the second light emitting diode string 222 may be about 2.5 mA.

When the mode enable signal HDR_EN is transited to the first level from the second level, the current flowing through each of the first light emitting diode string 221 and the second light emitting diode string 222 decreases to about 2.5 mA from about 5 mA. Accordingly in such an embodiment, the lowest light emitting brightness of the first light emitting diode string 221 and the second light emitting diode string 222 may be further decreased.

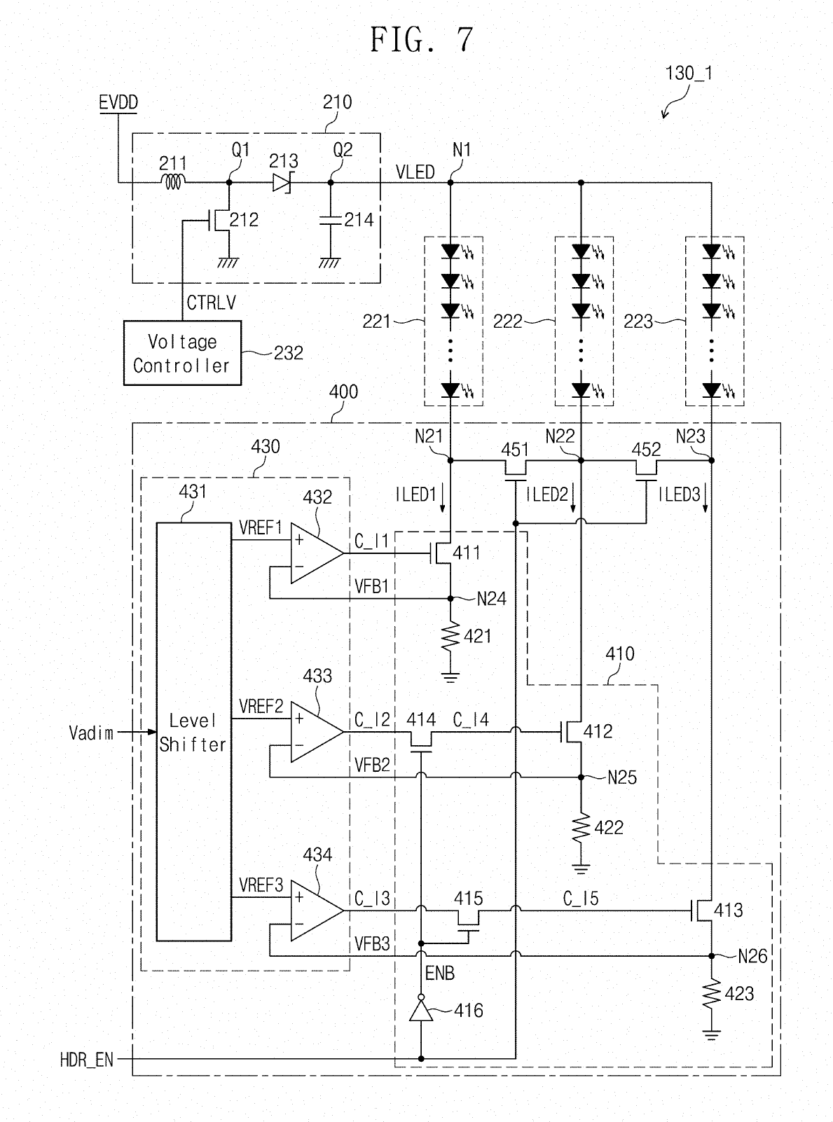

FIG. 7 is a circuit diagram showing a configuration of a backlight unit 130_1 according to an alternative exemplary embodiment of the disclosure. The backlight unit 130_1 shown in FIG. 7 is substantially the same as the backlight unit 130 shown in FIG. 5, and thus different features of the backlight unit 130_1 from those of the backlight unit 130 will be mainly described.

In an exemplary embodiment, as shown in FIG. 7, the backlight unit 130_1 includes three light emitting diode strings, i.e., first, second, and third light emitting diode strings 221, 222, and 223.

A current controller 400 includes a feedback control circuit 410, a dimming control circuit 430, a first switching unit 451 and a second switching unit 452.

The feedback control circuit 410 includes first, second, third, fourth and fifth transistors 411, 412, 413, 414 and 415, first, second, and third resistors 421, 422 and 423, and an inverter 416. The first resistor 421 is connected between the fourth node N24 and the ground terminal that receives the ground voltage. The second resistor 422 is connected between a fifth node N25 and the ground terminal that receives the ground voltage. The third resistor 423 is connected between a sixth node N26 and the ground terminal that receives the ground voltage. In such an embodiment, as shown in FIG. 7 and as described above with reference to FIG. 5, the feedback control circuit 410 selectively outputs a second current control signal C_I2 as a fourth current signal C_I4 in response to the mode enable signal HDR_EN, and selectively outputs a third control signal C_I3 as a fifth current signal C_I5 in response to the mode enable signal HDR_EN.

The dimming control circuit 430 includes a level shifter 431 and first, second and third comparators 432, 433 and 434. The level shifter 431 converts the dimming voltage signal Vadim to a first reference voltage VREF1, a second reference voltage VREF2, and a third reference voltage VREF3. The first comparator 432 compares the first reference voltage VREF1 with the first feedback voltage VFB1 to output a first current control signal C_I1 based on a result of the comparison. The second comparator 433 compares the second reference voltage VREF2 with the second feedback voltage VFB2 to output a second current control signal C_I2 based on a result of the comparison. The third comparator 434 compares the third reference voltage VREF3 with a third feedback voltage VFB3 to output the third current control signal C_I3 based on a result of the comparison. In such an embodiment, as shown in FIG. 7, a first current ILED1 flowing through the first transistor 411, a second current ILED2 flowing through the second transistor 412 and a third current ILED3 flowing through the third transistor 413 may be controlled depending on the voltage level of the first current control signal C_I1, the fourth current control signal C_I4 and the fifth current control signal C_I5, respectively.

The first switching unit 451 electrically connects a first node N21 of the first light emitting diode string 221 to a second node N22 of the second light emitting diode string 222 in response to a mode enable signal HDR_EN. The first switching unit 451 may be a transistor including one end connected to the first node N21, the other end connected to the second node N22, and a control electrode that receives the mode enable signal HDR_EN.

The second switching unit 452 electrically connects the second node N22 of the second light emitting diode string 222 to a third node N23 of the third light emitting diode string 223 in response to the mode enable signal HDR_EN. The second switching unit 452 may be a transistor including one end connected to the second node N22, the other end connected to the third node N23, and a control electrode that receives the mode enable signal HDR_EN.

The inverter 416 receives the mode enable signal HDR_EN and outputs an inverted enable signal ENB. The fourth transistor 414 is connected between an output terminal of the second comparator 433 of the dimming control circuit 430 and the control electrode of the second transistor 412, and includes a control electrode connected to an output terminal of the inverter 416. The fifth transistor 415 is connected between an output terminal of the third comparator 434 of the dimming control circuit 430 and a control electrode of the third transistor 413, and includes a control electrode connected to the output terminal of the inverter 416.

When the mode enable signal HDR_EN is at a first level (e.g., a high level), the fourth and fifth transistors 414 and 415 are turned off, and the first and second switching units 451 and 452 are turned on. When the fourth and fifth transistors 414 and 415 are turned off, the second current control signal C_I2 and the third current control signal C_I3 are not applied to the control electrodes of the second and third transistors 412 and 413. When the first and second switching units 451 and 452 are turned on, the first node N21 of the first light emitting diode string 221, the second node N22 of the second light emitting diode string 222, and the third node N23 of the third light emitting diode string 223 are electrically connected to each other. When the first, second and third nodes N21, N22 and N23 are electrically connected to each other, the currents flowing through the first, second and third nodes N21, N22 and N23 may be controlled by the first transistor 411.

Since the dimming voltage signal Vadim has the lowest level when the mode enable signal HDR_EN is at the first level, the first reference voltage VREF1 has a lower limit voltage level (e.g., about 0.125 V). Accordingly, a sum of the currents flowing through the first, second and third nodes N21, N22 and N23 may be controlled to be in a level corresponding to the lower limit voltage level of the first reference voltage VREF1.

Since the mode enable signal HDR_EN is transited to the first level from the second level, the current flowing through each of the first, second and third light emitting diode strings 221, 222 and 223 decreases. Accordingly, in such an embodiment, the lowest light emitting brightness of the first, second, and third light emitting diode strings 221, 222 and 223 may further decrease.

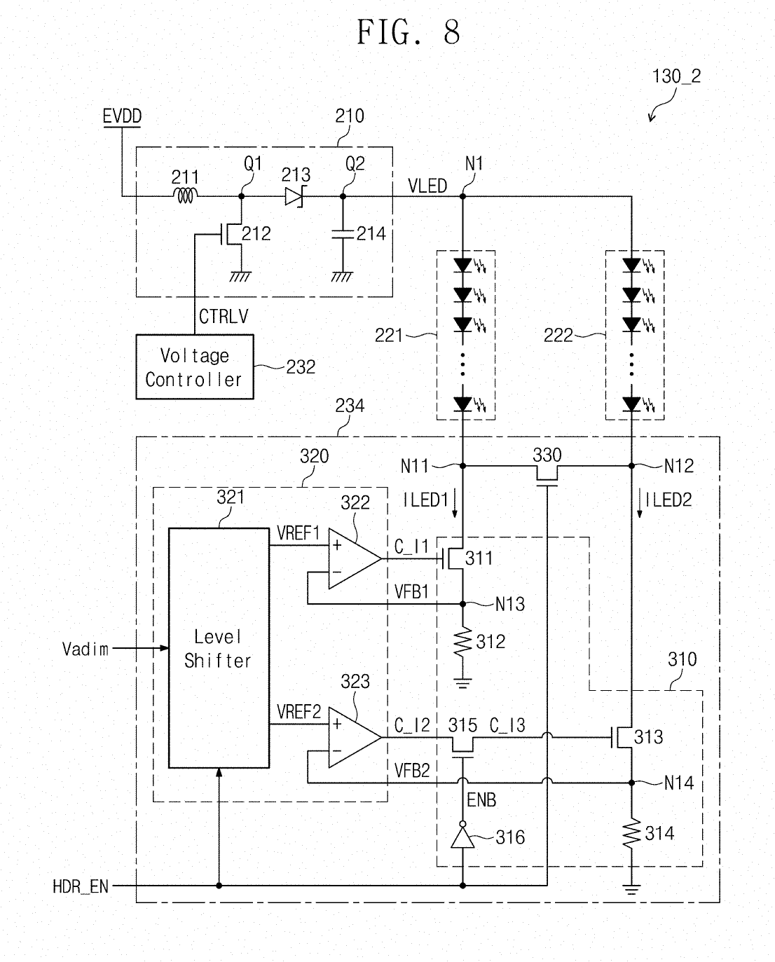

FIG. 8 is a circuit diagram showing a configuration of a backlight unit 130_2 according to another alternative exemplary embodiment of the disclosure. The backlight unit 130_2 shown in FIG. 8 is substantially the backlight unit 130 shown in FIG. 5, and thus different features of the backlight unit 130_2 from those of the backlight unit 130 will be mainly described.

In an exemplary embodiment, as shown in FIG. 8, a level shifter 321 of a dimming control circuit 320 receives a dimming voltage signal Vadim and a mode enable signal HDR_EN, and outputs first and second reference voltages VREF1 and VREF2 based on the dimming voltage signal Vadim and the mode enable signal HDR_EN.

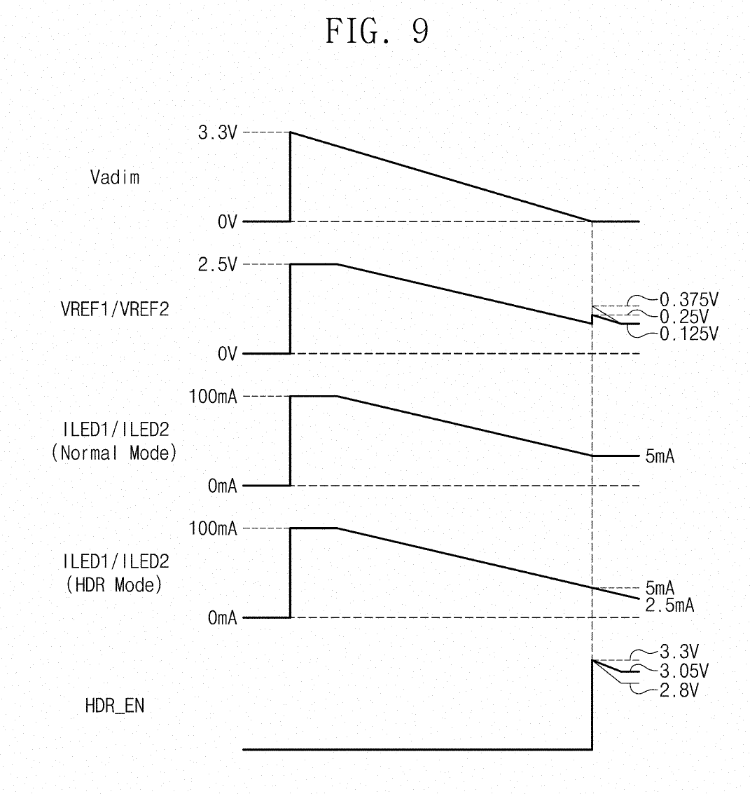

FIG. 9 is a timing diagram showing signals for an operation of a backlight unit according to an alternative exemplary embodiment of the disclosure.

Referring to FIGS. 1, 8 and 9, the mode enable signal HDR_EN is a voltage signal that gradually decreases from the first level (e.g., the high level of about 3.3 V) when the display apparatus 100 operates in the HDR mode and the dimming voltage signal Vadim is at the lowest level. The mode enable signal HDR_EN is set to the second level (e.g., the low level of about 0 V) when the display apparatus 100 operates in the normal mode or when the dimming voltage signal Vadim is not at the lowest level even though the display apparatus 100 operates in the HDR mode. According to an alternative embodiment, the mode enable signal HDR_EN is set to the first level (e.g., the high level) during the low brightness mode, in which the lowest brightness of the backlight is changed to be lower than the lowest brightness, and the mode enable signal HDR_EN is set to the second level (e.g., the low level) during the normal mode.

In an exemplary embodiment, the low brightness mode indicates that the display apparatus 100 operates in the HDR mode and the dimming voltage signal Vadim is at the lowest level. In such an embodiment, the mode enable signal HDR_EN gradually decreases from about 3.3 V to about 3.05 V during the low brightness mode. In such an embodiment, when mode enable signal HDR_EN is higher than a predetermined level (e.g., about 2.0 V), the switching unit 330 is turned on, and the third transistor 315 is turned off.

The level shifter 321 increases the first reference voltage VREF1 two times from about 0.125 V to about 0.25 V while the mode enable signal HDR_EN gradually decreases from about 3.3 V to about 3.05 V and decreases the first reference voltage VREF1 in proportion to a slope of voltage change of the mode enable signal HDR_EN. The first reference voltage VREF1 may gradually decrease from about 0.25 V to about 0.125 V when the mode enable signal HDR_EN gradually decreases from about 3.3 V to about 3.05 V.

The first current ILED1 and the second current ILED2 flowing through the first light emitting diode string 221 and the second light diode string 222, respectively may gradually decrease from about 5 mA to about 2.5 mA by the operation of the first comparator 322 and the first transistor 311 when the first reference voltage VREF1 gradually decreases from about 0.25 V to about 0.125 V.

According to an alternative embodiment, where the backlight unit 130_3 includes three light emitting diode strings as shown in FIG. 8, the mode enable signal HDR_EN may gradually decrease from about 3.3 V to about 2.8 V. The level shifter 321 increases the first reference voltage VREF1 three times from about 0.125 V to about 0.375 V while the mode enable signal HDR_EN gradually decreases from about 3.3 V to about 2.8 V and decreases the first reference voltage VREF1 in proportion to a slope of voltage change of the mode enable signal HDR_EN. The first reference voltage VREF1 may gradually decrease from about 0.375 V to about 0.125 V when the mode enable signal HDR_EN gradually decreases from about 3.3 V to about 2.8 V.

The current flowing through each of the first, second and third light emitting diode strings may gradually decrease from about 5 mA to about 2.5 mA when the first reference voltage VREF1 gradually decreases from about 0.375 V to about 0.125 V.

While the invention has been particularly shown and described with reference to exemplary embodiments thereof, it will be understood by those of ordinary skill in the art that various changes in form and details may be made therein without departing from the spirit or scope of the invention as defined by the following claims.

What is claimed is:

1. A backlight unit comprising:
a power converter which generates a light source power voltage to a power node;
a first light emitting diode string connected between the power node and a first node to receive the light source power voltage through the power node;
a second light emitting diode string connected between the power node and a second node to receive the light source power voltage through the power node; and
a current controller which controls a current flowing through the first node of the first light emitting diode string and a current flowing through the second node of the second light emitting diode string in response to a dimming voltage signal,
wherein the current controller comprises a switching unit which electrically connects the first node of the first light emitting diode string to the second node of the second light emitting diode string in response to a mode enable signal.

2. The backlight unit of claim 1, wherein the current controller substantially simultaneously controls the current flowing through the first node of the first light emitting diode string and the current flowing through the second node of the second light emitting diode string in response to the dimming voltage signal when the mode enable signal is at a first level.

3. The backlight unit of claim 1, wherein the current controller further comprises:
a feedback control circuit which generates a first feedback voltage corresponding to the current flowing through the first node and a second feedback voltage corresponding to the current flowing through the second node; and
a dimming control circuit which outputs a first current control signal based on the dimming voltage signal and the first feedback voltage and outputs a second current control signal based on the dimming voltage signal and the second feedback voltage,
wherein the feedback control circuit controls the current flowing through the first node in response to the first current control signal and controls the current flowing through the second node in response to the second current control signal.

4. The backlight unit of claim 3, wherein the feedback control circuit controls the current flowing through the second node in response to the second current control signal when the mode enable signal is at a second level.

5. The backlight unit of claim 3, wherein the feedback control circuit comprises:
a first current control transistor connected between the first node and a third node and comprising a control electrode which receives the first current control signal;
a first resistor connected between the third node and a ground terminal;
a control switching unit which selectively outputs the second current control signal as a third current control signal in response to the mode enable signal;
a second current control transistor connected between the second node and a fourth node and comprising a control electrode which receives the third current control signal; and
a second resistor connected between the fourth node and the ground terminal.

6. The backlight unit of claim 3, wherein the dimming control circuit comprises:
a level shifter which converts the dimming voltage signal to a first reference voltage and a second reference voltage;
a first comparator which compares the first reference voltage with the first feedback voltage to output the first current control signal; and
a second comparator which compares the second reference voltage with the second feedback voltage to output the second current control signal.

7. The backlight unit of claim 6, wherein
the level shifter converts the dimming voltage signal to the first reference voltage and the second reference voltage, wherein each of the first reference voltage and the second reference voltage is in a range between an upper limit voltage level and a lower limit voltage level.

8. The backlight unit of claim 7, wherein the current controller controls the current flowing through the first node such that the current flowing through the first node becomes lower than a current corresponding to the lower limit voltage level of the first reference voltage when the mode enable signal is at a first level and the first reference voltage is at the lower limit voltage level.

9. The backlight unit of claim 7, wherein the current controller controls the current flowing through the first node such that the current flowing through the first node varies to a current corresponding to the lower limit voltage level of the first reference voltage when the mode enable signal is at a second level and the first reference voltage is at the lower limit voltage level.

10. The backlight unit of claim 7, wherein the level shifter further receives the mode enable signal and generates the first reference voltage corresponding to a variation in voltage level of the dimming voltage signal and the mode enable signal.

11. A display apparatus comprising:
a display panel comprising a plurality of pixels;
a driving circuit which controls the display panel to display an image; and
a backlight unit which provides a light to the display panel,
wherein the backlight unit comprises:
a power converter which generates a light source power voltage to a power node;
a first light emitting diode string connected between the power node and a first node to receive the light source power voltage through the power node;
a second light emitting diode string connected between the power node and a second node to receive the light source power voltage through the power node; and
a current controller which controls a current flowing through the first node of the first light emitting diode string and a current flowing through the second node of the second light emitting diode string in response to a dimming voltage signal,
wherein the current controller comprises a switching unit which electrically connects the first node of the first light emitting diode string to the second node of the second light emitting diode string in response to a mode enable signal.

12. The display apparatus of claim 11, wherein the driving circuit provides the dimming voltage signal and the mode enable signal to the backlight unit.

13. The display apparatus of claim 11, wherein the current controller substantially simultaneously controls the current flowing through the first node of the first light emitting diode string and the current flowing through the second node of the second light emitting diode string in response to the dimming voltage signal when the mode enable signal is at a first level.

14. The display apparatus of claim 11, wherein the current controller further comprises:
a feedback control circuit which generates a first feedback voltage corresponding to the current flowing through the first node and a second feedback voltage corresponding to the current flowing through the second node; and
a dimming control circuit which outputs a first current control signal based on the dimming voltage signal and the first feedback voltage and outputs a second current control signal based on the dimming voltage signal and the second feedback voltage,
wherein the feedback control circuit controls the current flowing through the first node in response to the first current control signal and controls the current flowing through the second node in response to the second current control signal.

15. The display apparatus of claim 14, wherein the feedback control circuit controls the current flowing through the second node in response to the second current control signal when the mode enable signal is at a second level.

16. The display apparatus of claim 14, wherein the feedback control circuit comprises:
a first current control transistor connected between the first node and a third node and comprising a control electrode which receives the first current control signal;
a first resistor connected between the third node and a ground terminal;
a control switching unit which selectively outputs the second current control signal as a third current control signal in response to the mode enable signal;
a second current control transistor connected between the second node and a fourth node and comprising a control electrode which receives the third current control signal; and
a second resistor connected between the fourth node and the ground terminal.

17. The display apparatus of claim 14, wherein the dimming control circuit comprises:
a level shifter which converts the dimming voltage signal to a first reference voltage and a second reference voltage;
a first comparator which compares the first reference voltage with the first feedback voltage to output the first current control signal; and
a second comparator which compares the second reference voltage with the second feedback voltage to output the second current control signal.

18. The display apparatus of claim 17, wherein
the level shifter converts the dimming voltage signal to the first reference voltage and the second reference voltage,
wherein each of the first reference voltage and the second reference voltage is in a range between an upper limit voltage level and a lower limit voltage level.

19. The display apparatus of claim 18, wherein the current controller controls the current flowing through the first node such that the current flowing through the first node becomes lower than a current corresponding to the lower limit voltage level of the first reference voltage when the mode enable signal is at a first level and the first reference voltage is at the lower limit voltage level.

20. The display apparatus of claim 11, wherein the driving circuit comprises:
a data driver which drives a plurality of data lines;
a gate driver which drives a plurality of gate lines; and
a timing controller which controls the data driver and the gate driver in response to an image signal and a control signal, which are provided thereto from an external source,
wherein the timing controller provides the dimming voltage signal and the mode enable signal to the backlight unit.
